(19) United States
(12) Patent Application Publication
(10) Pub. No.: US 2007/0134074 A1
(43) Pub. Date: Jun. 14, 2007

(54) Screwed connection

(76) Inventors: Bernhard Arnold, Roden-Ansbach (DE); Nicolas Daboval, Wurzburg (DE); Karl Huber, Lengfurt (DE); Steffen Jung, Columbia, SC (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 10/598,100

(22) PCT Filed: Jan. 19, 2005
(86) PCT No.: PCT/EP05/50196

§ 371 Date: Aug. 17, 2006

(30) Foreign Application Priority Data
Feb. 20, 2004 (DE) 102004008477.7

(51) Int. Cl. F16B 39/34

(52) U.S. Cl. 411/930

(57) ABSTRACT

A screwed connection has at least one first component (1) which is provided with an internal screw thread (2) and which is screwed together with a second component (3) which is provided with a matching external screw thread (4). The screwed connection is used to transmit a tightening power (F). Thread sealants (6) are introduced between the external and the internal screw thread, thereby sealing the screwed connection.

### CROSS-REFERENCE TO RELATED APPLICATIONS

This application is a U.S. national stage application of International Application No. PCT/EP2005/050196 filed Jan. 19, 2005, which designates the United States of America, and claims priority to German application number DE 10 2004 008 477.7 filed Feb. 20, 2004, the contents of which are hereby incorporated by reference in their entirety.

### TECHNICAL FIELD

The invention relates to a screwed connection, comprising at least one first component into which an internal screw thread is threaded and which is screwed together with a second component which has a corresponding external screw thread.

### BACKGROUND

Screwed connections of this type are frequently used as sealing elements. For this purpose, a thread sealant is normally used which is introduced between the external screw thread and the internal screw thread over the entire length of thread. If it is intended to use such a screwed connection for simultaneously introducing a force, then the effect can be observed that a creeping of the sealant occurs. As a result, a setting of the screwed connection occurs and the clamping force of the screwed connection lessens. This can lead to a loss of seal of the screwed connection. In screwed connections which are intended to be permanently sealed, O-rings are therefore frequently used instead of thread sealants. In this case the screw thread takes over the function of transmitting the force and the O-ring that of sealing the screwed connection. However, the use of O-rings leads to higher component costs and an increased requirement in terms of construction space. At the same time, the assembly outlay in respect of the screwed connection increases.

### SUMMARY

The object of the invention is therefore to provide a screwed connection which, in a simple and inexpensive design, allows ease of assembly and provides both a secure seal and a good transmission of force.

The object can be achieved by a screwed connection comprising at least one first component into which an internal screw thread is introduced and which is screwed together with a second component which has a corresponding external screw thread, wherein a tightening force can be transmitted by means of the screwed connection, and wherein a thread sealant is introduced between the external and the internal screw thread in order to seal the screwed connection, and wherein the screwed connection has at least one first section and one second section, wherein the second section, in order to receive the thread sealant, is fashioned in a design deviating from that of the first section.

The external screw thread may have the same flank height in the first section and in the second section, and the external screw thread may have a smaller core diameter in the second section than in the first section, such that a continuous cavity is formed in the second section between the thread flanks of the internal screw thread and the thread flanks of the external screw thread, and that the cavity formed by the thread flanks is filled with thread sealant. The internal screw thread may have the same flank height in the first section and in the second section, and the internal screw thread may have a larger core diameter in the second section than in the first section, such that a continuous cavity is formed in the second section between the thread flanks of the internal screw thread and the thread flanks of the external screw thread, and that the cavity formed by the thread flanks is filled with thread sealant. At least one thread course of the external screw thread may have a lower pitch than the remaining thread courses of the external screw thread, wherein the thread course with the lower pitch forms the transition from the first section to the second section and wherein the thread courses of the external screw thread are axially offset in relation to the thread courses of the internal screw thread in the second section such that a continuous cavity is formed in the second section between the thread flanks of the internal screw thread and the thread flanks of the external screw thread, and that the cavity formed by the thread flanks is filled with thread sealant. At least one thread course of the internal screw thread may have a greater pitch than the remaining thread courses of the internal screw thread, wherein the thread course with the greater pitch forms the transition from the first section to the second section and wherein the thread courses of the internal screw thread are axially offset in relation to the thread courses of the external screw thread in the second section such that a continuous cavity is formed in the second section between the thread flanks of the internal screw thread and the thread flanks of the external screw thread, and that the cavity formed by the thread flanks is filled with thread sealant. At least one storage space can be formed between the internal screw thread and the external screw thread, into which storage space excess thread sealant can be pressed when the screwed connection is tightened. The storage space can be formed by an annular slot in the internal screw thread and/or in the external screw thread. The thread flanks of the external screw thread may have a lower flank height in the second section than in the first section. The thread flanks of the internal screw thread may have a lower flank height in the second section than in the first section. The thread sealant can be contained exclusively in the second section of the screwed connection. The screwed connection may be used in a fuel pump.

The invention is distinguished in that a tightening force F can be transmitted by means of the screwed connection, a thread sealant being introduced between the external screw thread and the internal screw thread in order to seal the screwed connection and the screwed connection having at least one first section and one second section, the second section being fashioned in a design deviating from that of the first section in order to receive the thread sealant. The construction design avoids the setting effect of the screwed connection and achieves a permanently sealed screwed connection.

An advantageous embodiment of the invention provides that the external screw thread has the same flank height in the first section and in the second section and that the external screw thread has a smaller core diameter in the second section than in the first section. By this means, a continuous cavity is formed in the second section between the thread flanks of the internal screw thread and the thread flanks of the external screw thread. Thus, no direct contact exists in the second section of the screwed connection between the thread flanks of the internal screw thread and the thread flanks of the external screw thread. The transmission of the tightening force therefore takes place only in the first section in which the thread flanks of the internal screw thread and of the external screw thread are in direct contact with one another. The second section essentially assumes only the sealing function. For this purpose, the cavity is preferably completely filled with thread sealant.

A further advantageous embodiment of the invention provides an inverse design of the screwed connection. That is, the internal screw thread in the first section and in the second section of the screwed connection have the same flank height, and the internal screw thread has a larger core diameter in the second section than in the first section. Consequently, a continuous cavity is again produced in the second section between the thread flanks of the internal screw thread and the thread flanks of the external screw thread. The cavity formed by the thread flanks is preferably completely filled with thread sealant and consequently provides in turn a permanent and secure sealing of the screwed connection. The transmission of force again takes place essentially only in the first section.

A further advantageous embodiment of the invention provides that at least one thread course of the external screw thread has a smaller pitch than the remaining thread courses of the external screw thread. The thread course with the smaller pitch forms the transition from the first section of the screwed connection to the second section of the screwed connection. The thread courses of the external screw thread are as a result axially offset in the second section of the screwed connection relative to the thread courses of the internal screw thread in the second section of the screwed connection such that a continuous cavity is formed in the second section of the screwed connection between the thread flanks of the internal screw thread and the thread flanks of the external screw thread. Thus, no direct contact again exists in the second section of the screwed connection between the thread flanks of the internal screw thread and the thread flanks of the external screw thread. The transmission of the tightening force therefore takes place only in the first section, in which the thread flanks of the internal screw thread and of the external screw thread are in direct contact with one another. The second section again essentially assumes only the function of a seal. For this purpose, the cavity is preferably filled completely with thread sealant.

A further advantageous embodiment of the invention provides the inverse design of internal and external screw thread. That is, at least one thread course of the internal screw thread has a larger pitch than the remaining thread courses of the internal screw thread. The thread course with the larger pitch forms the transition from the first section of the screwed connection to the second section of the screwed connection. The thread courses of the internal screw thread are as a result axially offset in the second section of the screwed connection relative to the thread courses of the external screw thread in the second section of the screwed connection, such that a continuous cavity is formed in the second section of the screwed connection between the thread flanks of the internal screw thread and the thread flanks of the external screw thread. Thus, no direct contact again exists in the second section of the screwed connection between the thread flanks of the internal screw thread and the thread flanks of the external screw thread. The transmission of the tightening force therefore takes place only in the first section, in which the thread flanks of the internal screw thread and of the external screw thread are in direct contact with one another. The second section again assumes essentially only the function of a seal. For this purpose, the cavity is preferably completely filled with thread sealant.

The fashioning of a thread with different pitches is possible on modern CNC-controlled machine tools with nominal outlay and at no additional cost.

A further advantageous embodiment of the invention provides that at least one storage space is formed between the internal screw thread and the external screw thread, into which storage space excess thread sealant can be pressed when the screwed connection is tightened. This ensures that the thread flanks of the internal screw thread and of the external screw thread are in direct contact with one another in the section which serves the transmission of force. In this way, a creeping of the thread sealant and a setting of the screwed connection are prevented.

In a particularly advantageous embodiment of the invention, the storage space is formed by an annular slot in the internal screw thread and/or in the external screw thread. Such an annular slot is particularly simple to introduce, even subsequently, into the internal or external screw thread, for example by turning.

A further advantageous embodiment of the invention provides that the thread flanks of the external screw thread have a lower flank height in the second section than in the first section. As a result of the reduced flank height, isolated cavities are formed between the core diameter of the internal screw thread and the shorter thread flanks of the external screw thread. These cavities are preferably completely filled with thread sealant and assume the function of sealing the screwed connection. The transmission of force takes place via the contact surfaces of the thread flanks. The advantage of this embodiment is that the transmission of force occurs over the entire length of the screw thread and not only over a first section. Nonetheless, the force transmission and sealing functions are separate from one another so that a creeping of the thread sealant is again prevented. The reduction of the flank height can be taken into account during manufacture, or else fashioned subsequently, for example by turning off the thread flanks.

A further advantageous embodiment of the invention provides an inverse design, i.e. the thread flanks of the internal screw thread have a lower flank height in the second section than in the first section. As a result of the reduced flank height, isolated cavities are again formed between the core diameter of the internal screw thread and the shorter thread flanks of the external screw thread. These cavities are preferably completely filled with thread sealant and assume the function of sealing the screwed connection. The transmission of force takes place again via the contact surfaces of the screw thread flanks and thus over the entire length of the screw thread. The reduction of the flank height can be taken into account during manufacture or else be fashioned subsequently, for example by turning off the thread flanks.

A particularly advantageous embodiment of the invention provides that the screw thread sealant is contained exclusively in the second section of the screwed connection. This immediately produces in the first section of the screwed connection a direct contact between the thread flanks of the internal and of the external screw thread. It is thus not necessary to press the thread sealant out of the first section by means of an increased input of force. Also, in this way no residues of the thread sealant remain between the thread flanks in the first section of the screwed connection. Such residues could possibly lead to a slight setting of the screwed connection occurring after some time.

The invention is distinguished by the fact that through simple and cost-effective design measures the screw thread of the screwed connection can be fashioned such that the force transmission and sealing functions are to a large extent separate from one another. The separation of transmission of force and sealing enables effective prevention of the setting phenomena and the creeping of the thread sealant which would otherwise be observed. The screw threads can be manufactured on modern CNC-controlled machine tools in one step without additional costs being incurred. Some embodiments of the invention can also be implemented subsequently in an existing screwed connection.

### BRIEF DESCRIPTION OF THE DRAWINGS

Exemplary embodiments of the invention are explained below with the aid of the schematic drawings, in which:

FIG. 1 shows a first exemplary embodiment of the invention, in which the external screw thread of the screwed connection has a smaller core diameter in the second section than in the first section of the screwed connection, the flank heights being the same,

FIG. 2 shows a second exemplary embodiment of the invention, in which the external screw thread of the screwed connection has a larger core diameter in the second section than in the first section of the screwed connection, the flank heights being the same.

FIG. 3 shows a third exemplary embodiment of the invention in which a storage space fashioned as an annular slot is fashioned between the internal screw thread and the external screw thread of the screwed connection,

FIG. 4 shows a fourth exemplary embodiment of the invention in which the flank height of the external screw thread in the second section of the screwed connection is reduced relative to the flank height of the external screw thread in the first section of the screwed connection,

FIG. 5 shows a fifth exemplary embodiment of the invention in which the flank height of the internal screw thread in the second section of the screwed connection is reduced relative to the flank height of the internal screw thread in the first section of the screwed connection,

FIG. 6 shows a sixth exemplary embodiment of the invention in which one thread course of the external screw thread has a lower pitch than the remaining thread courses of the external screw thread.

### DETAILED DESCRIPTION

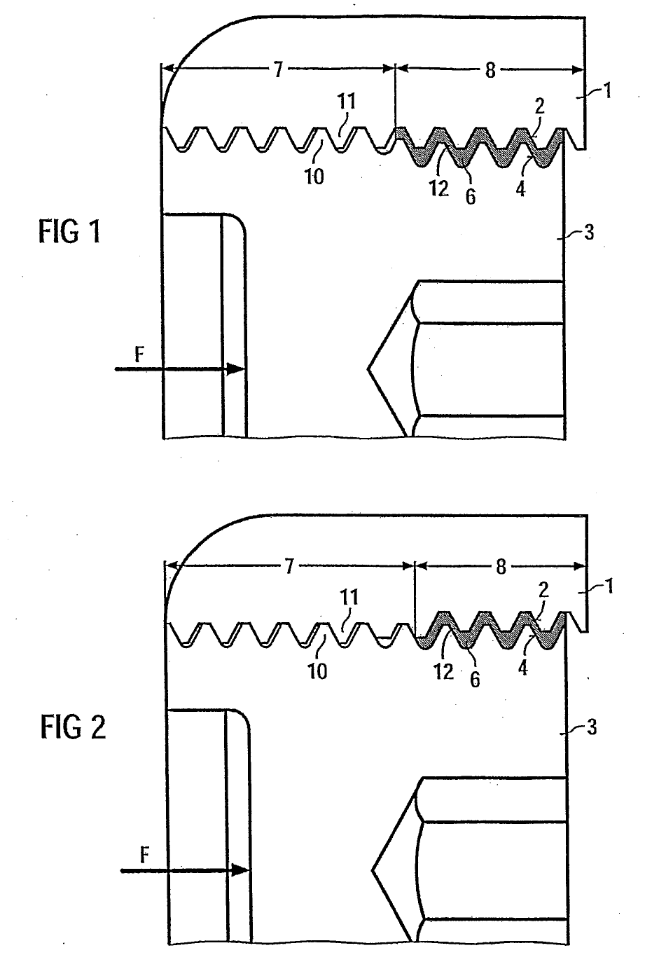

Elements of the same design and function are labeled with the same reference symbol throughout the drawings. In the inverse exemplary embodiments according to FIGS. 1 and 2, and FIGS. 4 and 5, the effect details and the advantages and disadvantages described there relate to both exemplary embodiments, even where no specific reference is made thereto.

FIG. 1 shows a screwed connection in which a first component 1, which has an internal screw thread 2, is screwed together with a second component 3 which has a corresponding external screw thread 4. The internal screw thread 2 is fashioned uniformly over the entire length of its thread, i.e. both the flank height and the core diameter and the internal diameter are even in dimension over the entire length of the thread. The external screw thread 4 likewise has a constant flank height over the entire length of its thread. However, the core diameter of the external screw thread 4 is larger in a first section 7 than in a second section 8. The thread flanks 10 are thus set back slightly in the area of the second section 8 relative to the thread flanks 10 in the first section. As a result of this, the thread flanks 10 of the external screw thread 4 are in direct contact in the area of the first section 7 with the thread flanks 11 of the internal screw thread 2. In the second section 8, by contrast, a continuous cavity 12 is formed between the thread flanks 11 of the internal screw thread 2 and the thread flanks 10 of the external screw thread 4, i.e. the thread flanks in the second section 8 are not in direct contact with one another and, as a result, no transmission of force occurs between the thread flanks 10 of the external screw thread 4 and the thread flanks 11 of the internal screw thread 2 in the area of the second section 8. The cavity 12 is completely filled with a thread sealant 6. This produces a secure sealing of the screwed connection. The transmission of the tightening force F essentially occurs only in the first section 7, in which the thread flanks 10, 11 of the internal screw thread 2 and of the external screw thread 4 are in direct contact with one another. Consequently, the two functions of force transmission and sealing are separate from one another in the screwed connection shown. The thread sealant 6 is advantageously introduced exclusively in the second section 8. The screw thread can be manufactured simply and cheaply with a CNC-controlled machine tool with no additional outlay. Setting of the screwed connection due to creeping of the thread sealant is avoided. This produces a permanently sealed screwed connection.

FIG. 2 shows a second exemplary embodiment of the invention. The exemplary embodiment in this case is inverse in relation to the exemplary embodiment in FIG. 1. The continuous cavity 12 in the second section 8 of the screwed connection is produced as a result of the fact that the core diameter of the internal screw thread 2 in the second section 8 is fashioned so as to be larger than the core diameter of the internal screw thread 2 in the first section 7. The thread flanks 10, 11 are thus not in direct contact with one another in the second section 7 and cannot therefore transmit any tightening force. In order to seal the screwed connection, the cavity 12 is completely filled with thread sealant. In the first section 7 of the internal screwed connection, by contrast, the thread flanks 11 of the internal screw thread 2 are in direct contact with the thread flanks 10 of the external screw thread 4 and are thus able to transmit a tightening force F. Consequently the force transmission and sealing function of the screwed connection are again separate from one another.

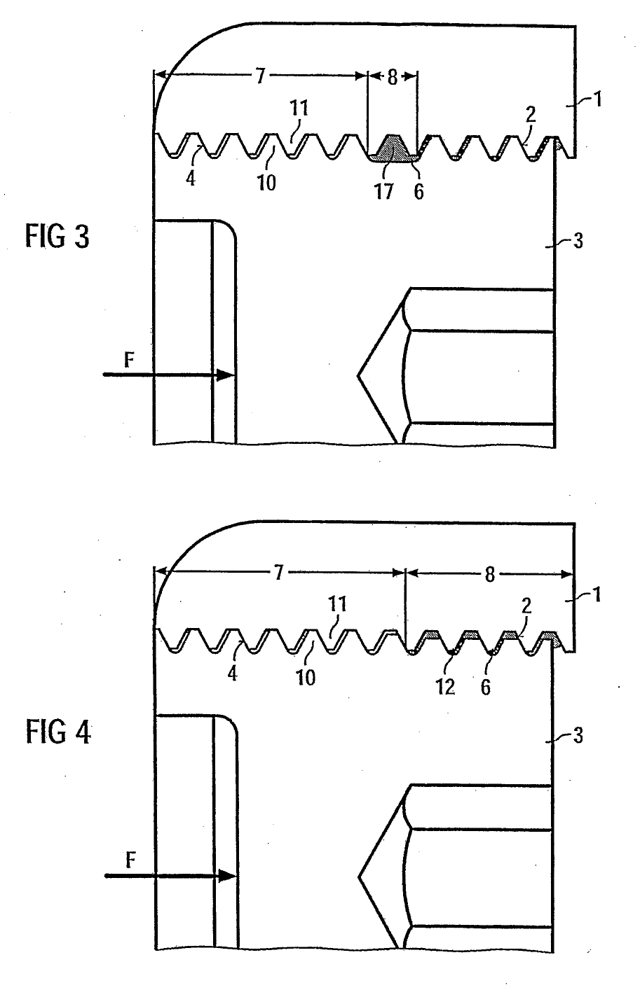

FIG. 3 shows a third exemplary embodiment of a screwed connection. In this exemplary embodiment, both the internal screw thread 2 and the external screw thread 4 are fashioned evenly over the entire length of thread. The thread flanks 10 of the external screw thread 4 and the thread flanks 11 of the internal screw thread 2 are in direct contact with one another over the entire thread length. However, a storage space 17 is fashioned between the internal screw thread 2 and the external screw thread 4. The storage space 17 can be fashioned by omitting one or more thread courses in the internal and/or external screw thread 2, 4. The storage space 17 can, however, also be fashioned subsequently, for example by turning in an annular slot. The storage space 17 makes it possible for excess thread sealant to be pressed into this storage space 17 when the screwed connection is tightened. In this way, the storage space 17 is completely filled with thread sealant. The section of the screwed connection in which the storage space 17 is fashioned then assumes the function of sealing the screwed connection. The tightening force F is transmitted via the thread flanks 10, 11. The separation of sealing function and force transmission produces in turn a secure and permanent sealing of the screwed connection.

FIG. 4 shows a further exemplary embodiment of a screwed connection. Here, the thread flanks 10 of the external screw thread 4 have a reduced flank height in a second section 8, relative to the flank height in a first section 7. As a result of the reduction of the flank height in the second section 8, isolated cavities 12 are formed between the core diameter of the internal screw thread 2 and the reduced thread flanks of the external screw thread 4. These cavities 12 are filled completely with a thread sealant 6. The tightening force F of the screwed connection, on the other hand, is transmitted exclusively in the contact area between the thread flanks of the internal and external screw thread 2, 4. This contact area is essentially free of thread sealant 6, so that no setting of the screwed connection takes place. Consequently, the sealing of the screwed connection and the transmission of force are again taken over by two areas of screw thread that are largely independent of one another.

Thread sealant which, when the screwed connection is assembled, is still located in the contact area of the thread flanks is pressed by the tightening force F into the cavities 12. The thread sealant 6 is preferably applied before assembly only in the second section 8 of the screwed connection.

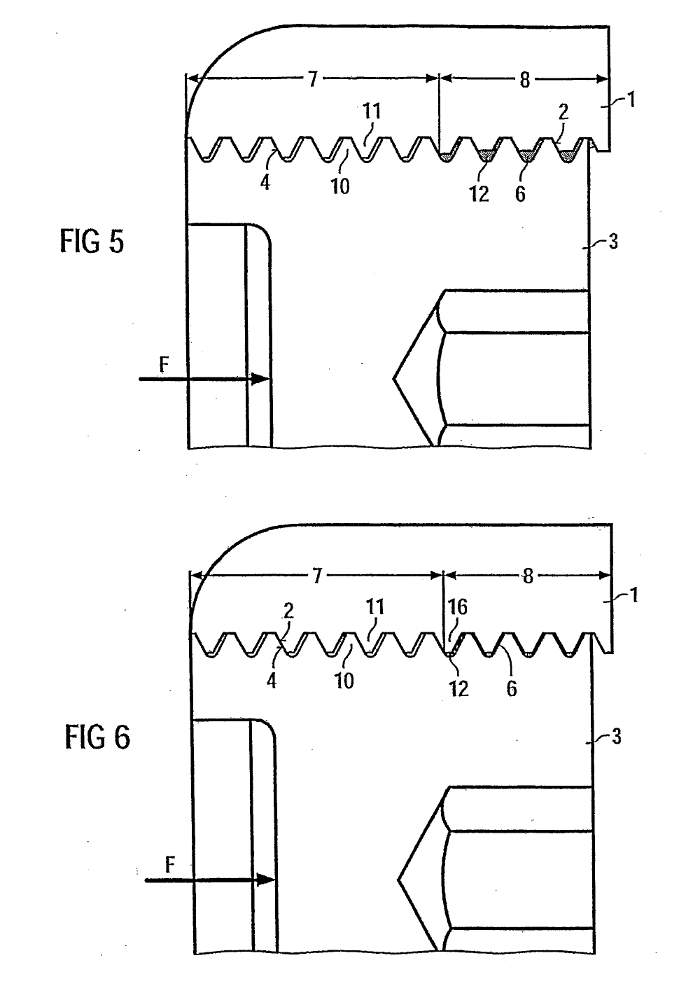

FIG. 5 shows a further exemplary embodiment of a screwed connection. In this exemplary embodiment the same idea is pursued as in the exemplary embodiment according to FIG. 4. In contrast to the latter exemplary embodiment, however, the thread flanks 11 of the internal screw thread 2 are reduced in a second section 8 relative to the thread flanks 10 in a first section 7. Through reduction of the flank height in the second section 8, isolated cavities 12 are formed in the second section 8 between the core diameter of the external screw thread 4 and the reduced thread flanks of the internal screw thread 2. These cavities 12 are again completely filled with a thread sealant 6 and assume the function of sealing the screwed connection.

It is of course also possible for both the thread flanks 10 of the external screw thread 4 and the thread flanks 11 of the internal screw thread 2 to be reduced in height in the second section 8.

The exemplary embodiments according to FIG. 4 and FIG. 5 have the advantage that the transmission of force takes place over the entire length of the thread and not only in a first section 7. However, the contact area between the thread flanks 10, 11 of the internal and of the external screw thread is somewhat reduced in the second section 8 compared with the first section 7. The reduced flank height can be produced, for example, by turning on a CNC machine, without additional costs being incurred. The reduction of the flank height can also be produced with ease subsequently, for example by turning off the external diameter or the internal diameter.

FIG. 6 shows a final exemplary embodiment of the invention. In this exemplary embodiment at least one thread course of the external screw thread 4 has a lower pitch than the remaining thread courses of the external screw thread 4. As a result of this, the thread courses of the external screw thread 4 are, subsequently, axially offset relative to the thread courses of the internal screw thread 2. Two different screw thread sections are formed here. In a first section 7, the thread flanks 10, 11 are in direct contact with one another. The tightening force is transmitted over the contact areas of the thread flanks. In a second section 8 which begins with the thread course with the lower pitch no direct contact exists between the thread flanks 10 of the external screw thread 4 and the thread flanks 11 of the internal screw thread 2. As a result of the external screw thread being offset, a continuous cavity 12 is produced in the second section. The cavity 12 is completely filled with thread sealant and thus provides a secure sealing of the screwed connection. The transmission of force of the screwed connection is essentially carried out by the first section 7, in which the thread flanks 10 of the external screw thread 4 are in direct contact with the thread flanks 11 of the internal screw thread 2.

It is, of course, also possible for at least one thread course 16 of the internal screw thread 2 to have a larger pitch than the remaining thread courses of the internal screw thread. Through this measure, the thread courses of the internal screw thread 2 are axially offset relative to the thread courses of the external screw thread 4 in the second section such that a continuous cavity is in turn produced in the second section 8 between the thread flanks 11 of the internal screw thread 2 and the thread flanks 10 of the external screw thread 4.

A change in the thread pitch can easily be produced, for example by turning on a CNC-controlled machine tool, without additional costs being incurred.

Of course, several of the measures described can also be combined with one another. In this way, a further improved sealing of the screwed connection can be produced.

What is claimed is:

1. A screwed connection comprising at least one first component into which an internal screw thread is introduced and which is screwed together with a second component which has a corresponding external screw thread, wherein a tightening force can be transmitted by means of the screwed connection, and wherein a thread sealant is introduced between the external and the internal screw thread in order to seal the screwed connection, and wherein the screwed connection has at least one first section and one second section, wherein the second section, in order to receive the thread sealant, is fashioned in a design deviating from that of the first section.

2. A screwed connection according to claim 1, wherein the external screw thread has the same flank height in the first section and in the second section, and the external screw thread has a smaller core diameter in the second section than in the first section, such that a continuous cavity is formed in the second section between the thread flanks of the internal screw thread and the thread flanks of the external screw thread, and that the cavity formed by the thread flanks is filled with thread sealant.

3. A screwed connection according to claim 1, wherein the internal screw thread has the same flank height in the first section and in the second section, and the internal screw thread has a larger core diameter in the second section than in the first section, such that a continuous cavity is formed in the second section between the thread flanks of the internal screw thread and the thread flanks of the external screw thread, and that the cavity formed by the thread flanks is filled with thread sealant.

4. A screwed connection according to claim 1, wherein at least one thread course of the external screw thread has a lower pitch than the remaining thread courses of the external screw thread, wherein the thread course with the lower pitch forms the transition from the first section to the second section and wherein the thread courses of the external screw thread are axially offset in relation to the thread courses of the internal screw thread in the second section such that a continuous cavity is formed in the second section between the thread flanks of the internal screw thread and the thread flanks of the external screw thread, and that the cavity formed by the thread flanks is filled with thread sealant.

5. A screwed connection according to claim 1, wherein at least one thread course of the internal screw thread has a greater pitch than the remaining thread courses of the internal screw thread, wherein the thread course with the greater pitch forms the transition from the first section to the second section and wherein the thread courses of the internal screw thread are axially offset in relation to the thread courses of the external screw thread in the second section such that a continuous cavity is formed in the second section between the thread flanks of the internal screw thread and the thread flanks of the external screw thread, and that the cavity formed by the thread flanks is filled with thread sealant.

6. A screwed connection according to claim 1, wherein at least one storage space is formed between the internal screw thread and the external screw thread, into which storage space excess thread sealant can be pressed when the screwed connection is tightened.

7. A screwed connection according to claim 6, wherein the storage space is formed by an annular slot in the internal screw thread and/or in the external screw thread.

8. A screwed connection according to claim 1, wherein the thread flanks of the external screw thread have a lower flank height in the second section than in the first section.

9. A screwed connection according to claim 1, wherein the thread flanks of the internal screw thread have a lower flank height in the second section than in the first section.

10. A screwed connection according to claim 1, wherein the thread sealant is contained exclusively in the second section of the screwed connection.

11. A screwed connection according to claim 1, wherein the screwed connection is used in a fuel pump.

12. A screwed connection comprising at least one first component having an inner thread and a second component having a corresponding external thread, wherein first and second components provide for a tightening force when screwed together, further comprising a thread sealant between the external and the internal screw thread in order to seal the screwed connection, and wherein the screwed connection has at least one first section and one second section, wherein the second section, in order to receive the thread sealant, is fashioned in a design deviating from that of the first section.

13. A screwed connection according to claim 12, wherein the external thread has the same flank height in the first section and in the second section, and the external thread has a smaller core diameter in the second section than in the first section, such that a continuous cavity is formed in the second section between the thread flanks of the internal screw thread and the thread flanks of the external screw thread, and that the cavity formed by the thread flanks is filled with thread sealant.

14. A screwed connection according to claim 12, wherein the internal thread has the same flank height in the first section and in the second section, and the internal thread has a larger core diameter in the second section than in the first section, such that a continuous cavity is formed in the second section between the thread flanks of the internal screw thread and the thread flanks of the external screw thread, and that the cavity formed by the thread flanks is filled with thread sealant.

15. A screwed connection according to claim 12, wherein at least one thread course of the external thread has a lower pitch than the remaining thread courses of the external screw thread, wherein the thread course with the lower pitch forms the transition from the first section to the second section and wherein the thread courses of the external thread are axially offset in relation to the thread courses of the internal screw thread in the second section such that a continuous cavity is formed in the second section between the thread flanks of the internal thread and the thread flanks of the external thread, and that the cavity formed by the thread flanks is filled with thread sealant.

16. A screwed connection according to claim 12, wherein at least one thread course of the internal thread has a greater pitch than the remaining thread courses of the internal thread, wherein the thread course with the greater pitch forms the transition from the first section to the second section and wherein the thread courses of the internal thread are axially offset in relation to the thread courses of the external thread in the second section such that a continuous cavity is formed in the second section between the thread flanks of the internal thread and the thread flanks of the external thread, and that the cavity formed by the thread flanks is filled with thread sealant.

17. A screwed connection according to claim 12, wherein at least one storage space is formed between the internal thread and the external thread, into which storage space excess thread sealant can be pressed when the screwed connection is tightened.

18. A screwed connection according to claim 17, wherein the storage space is formed by an annular slot in the internal thread and/or in the external thread.

19. A screwed connection according to claim 12, wherein the thread flanks of the external thread have a lower flank height in the second section than in the first section.

20. A screwed connection according to claim 1, wherein the thread flanks of the internal thread have a lower flank height in the second section than in the first section.
